(19) United States
(12) Patent Application Publication
(10) Pub. No.: US 2008/0081665 A1
(43) Pub. Date: Apr. 3, 2008

(54) Mobile phone

(75) Inventor: Yoshiaki Hata, Nishitokyo-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/809,860

(22) Filed: Jun. 1, 2007

(30) Foreign Application Priority Data
Sep. 29, 2006 (JP) 2006-268842

(51) Int. Cl. H04B 1/38

(52) U.S. Cl. 455/557

(57) ABSTRACT

A mobile phone for performing communication with respect to a plurality of data communication services has a setting storage part, and the setting storage part stores priority associated with the plurality of data communication services. When packet communication is started, a QoS control part controls a transmission part and a receiving part so as to carry out data communication with respect to other data communication services stored in the setting storage part based on the priority in parallel with the packet communication. In a case where the user carries out target data communication, periodical distribution of a registered content and so on are carried out in the background by QoS control. Therefore, efficient data communication effectively using resources is made possible, and reduction in the number of communications and communication time, and lowering of power consumption can be attempted.

### CROSS-REFERENCE TO RELATED APPLICATIONS

This application is based upon and claims the benefit of priority from prior Japanese Patent Application No. 2006-268842, filed Sep. 29, 2006, the entire contents of which are incorporated herein by reference.

### BACKGROUND OF THE INVENTION

1. Field of the Invention

The present invention relates to a mobile phone using QoS control.

2. Description of the Related Art

A hybrid mobile phone adopting cdma 1x EVDO (1x Evolution Data Only) as a communication system is in a best-effort system with incoming throughput of 153.6 kbps (EVDO) and maximum outgoing throughput of 2.4 Mbps (EVDO) under a base station based on an EVDO Rev. 0 (Evolution Data Only Revision 0) service, and Quality of Service is not guaranteed.

On contrary, in an EVDO Rev. A (Evolution Data Only Revision A) service implemented from the year of 2006, improvement is made in throughput to incoming throughput of 1.8 Mbps (EVDO) and outgoing throughput of 3.07 Mbps (EVDO), and also Quality of Service (QoS) is guaranteed. That is, according to the EVDO Rev. A service, priority (QoS Priority) is attached to each of a plurality of different data communication services (Service Instance), thereby a plurality of communications can be achieved simultaneously. In the EVDO Rev. A, each of the data communication services is managed in a Flow Profile ID (hereinafter, abbreviated to Flow-ID).

As a general technique using the QoS is disclosed in Jpn. Pat. Appln. Publication No. 2004-96216, for example. That is, in a system disclosed in Jpn. Pat. Appln. Publication No. 2004-96216, a contents distributor transmits a value of a QoS level to a reproducer, and the reproducer monitors reception of contents data based on the value of the QoS level.

Forms of the data communication services are largely classified into a form in which the user requires by the user's intention a service at an arbitrary timing, such as Web or E-mail, and so on, and a form in which a service is automatically provided regardless of the intention of the user in a state where provision of the service is registered, such as periodical distribution or automatic distribution of registered contents, and so on. Under the EVDO Rev. 0 base station described above, a plurality of communications cannot be carried out simultaneously. Therefore, periodical distribution of contents and so on, for example, are carried out during night time in which the user does not use communication, and the communication by the periodical distribution is set to be discontinued when user operation is carried out during the periodical distribution.

However, as described above, as for the data communication carried out automatically in the background, performing time of the data communication is allocated to a time period in which the user normally does not use a mobile phone in general. Therefore, for example, there is a case in which communication time becomes long when a large amount of data is communicated, and as a result, a battery wears out during non-charging time without the notice of the user. Further, the data communication is not necessarily carried out in a communication environment with an optimal radio state. Therefore, increase in the number of communications and communication time, and also increase in electric power consumption are generated.

### BRIEF SUMMARY OF THE INVENTION

An object of the present invention is to provide a mobile phone for performing efficient data communication by effectively using resources by performing periodical distribution and so on of a registered content in the background with a start of communication as a trigger when the user carries out target data communication by QoS control, and also attempting decrease in the number of communications and communication time and reduction in power consumption.

According to a first aspect of the present invention, there is provided a mobile phone for a communication in relation to a plurality of data communication services, comprising:

a storing part configured to store priorities relating to data communication services; and

a controlling part configured to control the mobile phone to carry out data communication in relation to other data communication services stored in the storing part based on the priority in parallel with packet communication if the packet communication is started.

According to a second aspect of the present invention, there is provided a mobile phone for a communication in relation to a plurality of data communication services, comprising:

an inputting part configured to permit an input of a starting operation of packet communication;

a storing part configured to store priorities relating to data communication services; and

a controlling part configured to control the mobile phone to carry out data communication in relation to other data communication services stored in the storing part based on the priority in parallel with packet communication if the packet communication is started in accordance with the starting operation.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing a configuration of a mobile phone according to an embodiment of the present invention;

FIG. 2 is an explanatory view showing a setting table stored in a setting storage part shown in FIG. 1;

FIG. 3 is a flowchart in a case of setting QoS communication information including priority, connection time, and so on of each data communication service in the mobile phone shown in FIG. 1;

FIG. 4 is a flowchart showing processing steps of QoS connection of services (Flow-IDs A and B) by the user's operation using the mobile phone in the mobile phone shown in FIG. 1;

FIG. 5 is a flowchart showing processing steps for carrying out additional connection of a distribution service (Flow-ID C) after the QoS connection of the Flow-IDs A and B in the mobile phone shown in FIG. 1;

FIG. 6 is a flowchart showing processing of each event after the QoS connection of the Flow-IDs A, B, and C in the mobile phone shown in FIG. 1;

FIG. 7 is a flowchart showing other processing of each event after connecting the Flow-IDs A, B, and C in the mobile phone in FIG. 1;

FIG. 8 is a flowchart further showing other processing of each event after connecting Flow-IDs A, C, and D in the mobile phone in FIG. 1;

FIG. 9 is a flowchart further showing still other processing of each event after connecting the Flow-IDs A and D in the mobile phone shown in FIG. 1; and

FIG. 10 is a flowchart showing other processing steps of the mobile phone in the mobile phone shown in FIG. 1.

### DETAILED DESCRIPTION OF THE INVENTION

Hereinafter, a mobile phone according to embodiments of the present invention will be described with reference to the accompanying drawings.

### First Embodiment

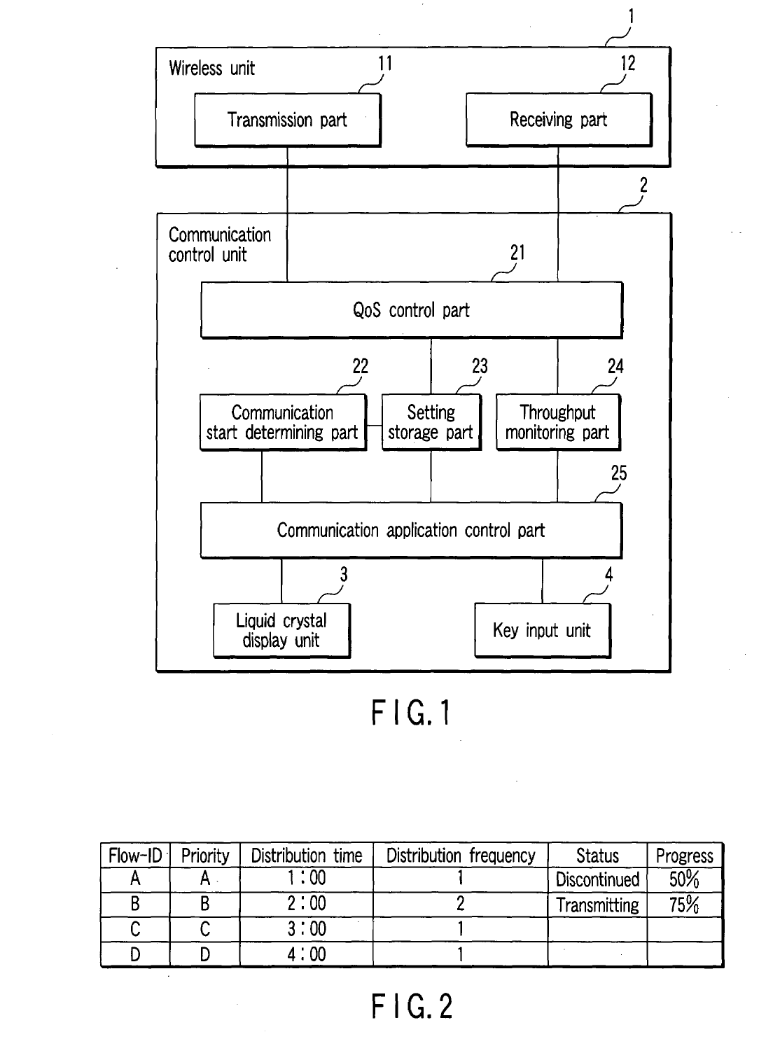

FIG. 1 shows a configuration of the mobile phone according to a first embodiment of the present invention.

As shown in FIG. 1, the mobile phone according to the present embodiment includes a wireless unit 1, a communication control unit 2, a liquid crystal display unit 3, and a key input unit 4 in which an instruction corresponding to the user's operation is input. Further, the wireless unit 1 includes a transmission part 11 and a receiving part 12, and the communication control unit 2 includes a QoS control part 21 which controls QoS, a determining part 22 which determines whether communication has been started, a storage part 23 which stores a setting condition set in the mobile phone, a throughput monitoring part 24, and a communication application control part 25 as a communication controlling means.

In the mobile phone configured as described above, the QoS introduced in an EVDO Rev. A service is used so that a plurality of data communications can be carried out simultaneously. That is, start of connection of packet communication in relation to Web or E-mail carried out intentionally by the user triggers the QoS control part 21 to carry out downloading and so on of a distribution content set in advance in parallel therewith. In addition, start of connection of IP telephone in which a voice call is carried out in packet communication triggers the QoS control part 21 to carry out downloading and so on of a distribution content. Further, the communication application control part 25 carries out setting of priority of a plurality of different data communication services and management of such services. That is, more specifically, the communication application control part 25 sets in advance priority of the data communication services generally started without the intention of the user, such as automatic distribution, and stores, for example, distribution time, distribution frequency, and so on, in a setting table format in the setting storage part 23 and manages such setting in an integrated manner.

An example of the setting table is shown, for example, in FIG. 2.

When communication under a base station based on the EVDO Rev. A is taken as an example, a control path used for a PPP control signal used in packet connection is set as Service Instance A (Flow-ID A), packet communication such as Web used by the user is set as Service Instance B (Flow-ID B), communication used in content distribution 1 is set as Service Instance C (Flow-ID C), and communication used in content distribution 2 is set as Service Instance D (Flow-ID D). The communication application control part 25 sets priority (QoS Priority) of the Flow-IDs A to D in advance. Here, priority is set to be A>B>C>D. In the setting table, other information including distribution time, distribution frequency, and progress of status (discontinuance, transmitting, and so on) are stored in association with the Flow-IDs. These items of information are collectively referred to as “QoS communication information”.

The communication start determining part 22 detects start of packet communication including Web and E-mail carried out by the intention of the user based on operation of the key input unit 4 and so on, and notifies the QoS control part 21 of the start. The start of the data communication carried out by the intention of the user triggers the QoS control part 21 to refer to the setting table of the setting storage part 23, check status of a distribution service, determine whether other communication services are connected simultaneously, and control the transmission part 11 and the receiving part 12 so as to start simultaneous communications as needed.

In addition, the QoS control part 21 controls the transmission part 11 and the receiving part 12 so as to finish the data communication carried out in the background if the data communication carried out by the intention of the user terminates. At this time, if discontinuance information is stored in a status section of the setting table of the setting storage part 23, the downloading of distribution can be resumed by referring to the discontinuance information at the time of the next connection by the user. In addition, the QoS control part 21 may control the transmission part 11 and the receiving part 12 so as to terminate other communication by increasing priority of the distribution content carried out in the background without cutting a communication session at the time of the termination of the data communication by the intention of the user. In addition, the QoS control part 21 monitors throughput of each data communication by the throughput monitoring part 24. Therefore, for example, if the throughput of data communication is slow and it is inefficient even if the data communication has high priority, the QoS control part 21 can dynamically increase priority of other services, that is, dynamically change priority in the middle of communication, to increase the overall communication efficiency. As a result, the QoS control part 21 can control the transmission part 11 and the receiving part 12 so as to avoid increase in entire communication time due to communication under a specific service.

Hereinafter, an explanation will be made with respect to processing steps in which the communication application control part 25 sets the QoS communication information including priority of each data communication service, distribution time, and distribution frequency in the setting table of the setting storage part 23 in the mobile phone according to the first embodiment of the present invention. The setting of the QoS communication information will be referred to as “QoS communication setting”.

If the communication application control part 25 starts processing from an EVDO/1x standby state (step S1), the communication application control part 25 determines whether the QoS communication setting of a communication application such as Web and E-mail and a registered distribution content is carried out (step S2). If the QoS communication setting is instructed by operation of the key input unit 4 by the user and so on, the communication application control part 25 determines whether such service is an automatic distribution service for which distribution time, the number of distribution, and so on can be set in advance (step S3). Here, if the service is determined as the automatic distribution service, the communication application control part 25 receives information including priority, distribution time, the number of distribution, and so on of an automatic distribution content input by operation of the key input unit 4 (step S4). On the other hand, if the service is not determined as the automatic distribution service, the communication application control part 25 receives information of priority of a communication application input by operation of the key input unit 4 (step S5). The communication application control part 25 registers the QoS communication information in the setting table of the setting storage part 23 (step S6), and determines whether there are other data communication services which require the QoS setting (step S7). If there is such a data communication service, the processing returns to step S3, and processing in steps S4 to S5 is repeated. On the other hand, if there is no such data communication service, the state of the mobile phone moves to the EVDO/1x standby state (step S1).

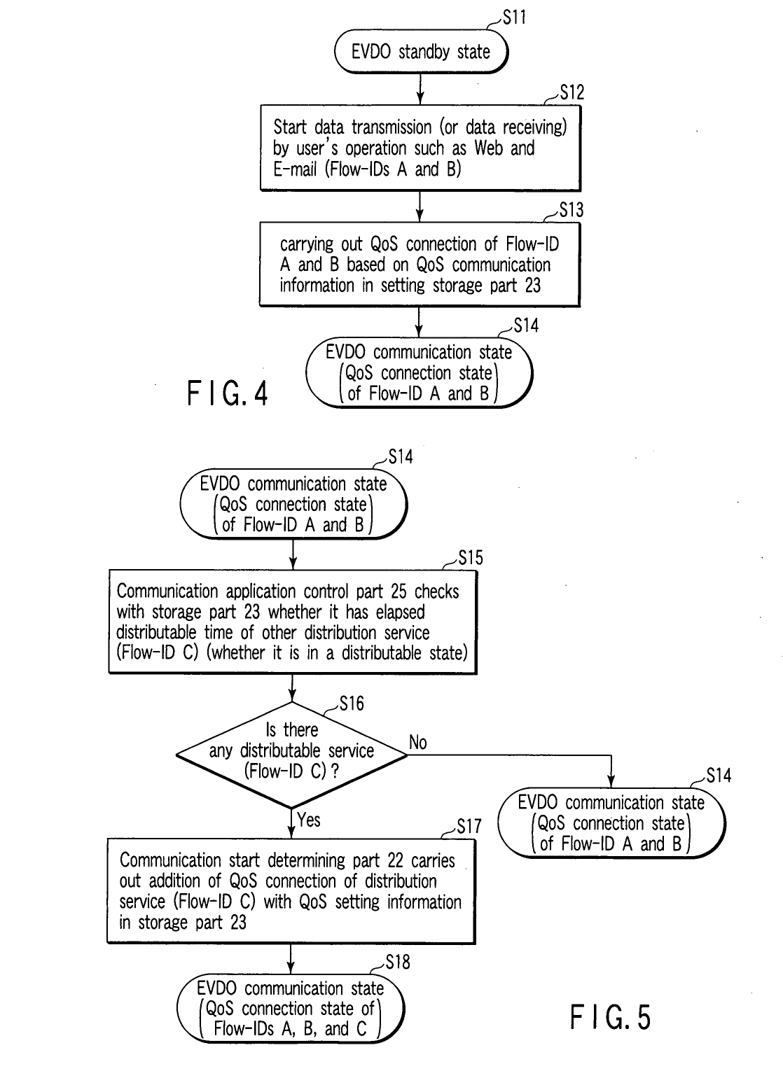

Next, a detailed explanation will be made with respect to processing steps of starting data communication for Web carried out by the user, starting downloading of a distribution content in the background simultaneously with the data communication, and discontinuing the downloading of the distribution content when the data communication is terminated, in the mobile phone according to the first embodiment of the present invention with reference to flowcharts in FIGS. 4 to 6.

First, processing steps of the QoS connection of services (Flow-IDs A and B) by operation of the key input unit 4 by the user with reference to the flowchart of FIG. 4 will be described.

If the QoS control part 21 starts processing from an EVDO standby state (step S11), the QoS control part 21 starts data communication (transmission or receiving) by the user's operation such as Web and E-mail (Flow-IDs A and B) (step S12), and the QoS control part 21 carries out the QoS connection of the Flow-IDs A and B based on the QoS communication information of the setting storage part 23 (step S13). In this manner, the state of the mobile phone moves to an EVDO communication state (connection state of the Flow-IDs A and B) (step S14). Each data communication service is carried out based on each priority managed by the communication application control part 25.

Next, processing steps for carrying out additional connection of a distribution service (Flow-ID C) after the QoS connection of the Flow-IDs A and B will be described with reference to a flowchart in FIG. 5.

In the EVDO communication state (QoS connection state of the Flow-IDs A and B) (step S14), the communication application control part 25 checks whether time capable of distributing the distribution service (Flow-ID C) has elapsed, that is, whether the distribution service is in a state capable of being distributed, by referring to the setting table of the setting storage part 23 (step S15). Then, the communication application control part 25 determines whether there is a distributable service (Flow-ID C) or not (step S16). Here, if there is the distributable service, the QoS control part 21 carries out addition of the QoS connection of the distribution service (Flow-ID C) based on the QoS setting information of the setting storage part 23 in accordance with start of the communication start determining part 22 (step S17). In this manner, the state of the mobile phone moves to the EVDO communication state (QoS connection state of the Flow-IDs A, B, and C) (step S18). In step S16, if there is no distributable service, the processing returns to the EVDO communication state (QoS connection state of the Flow-IDs A and B) (step S14).

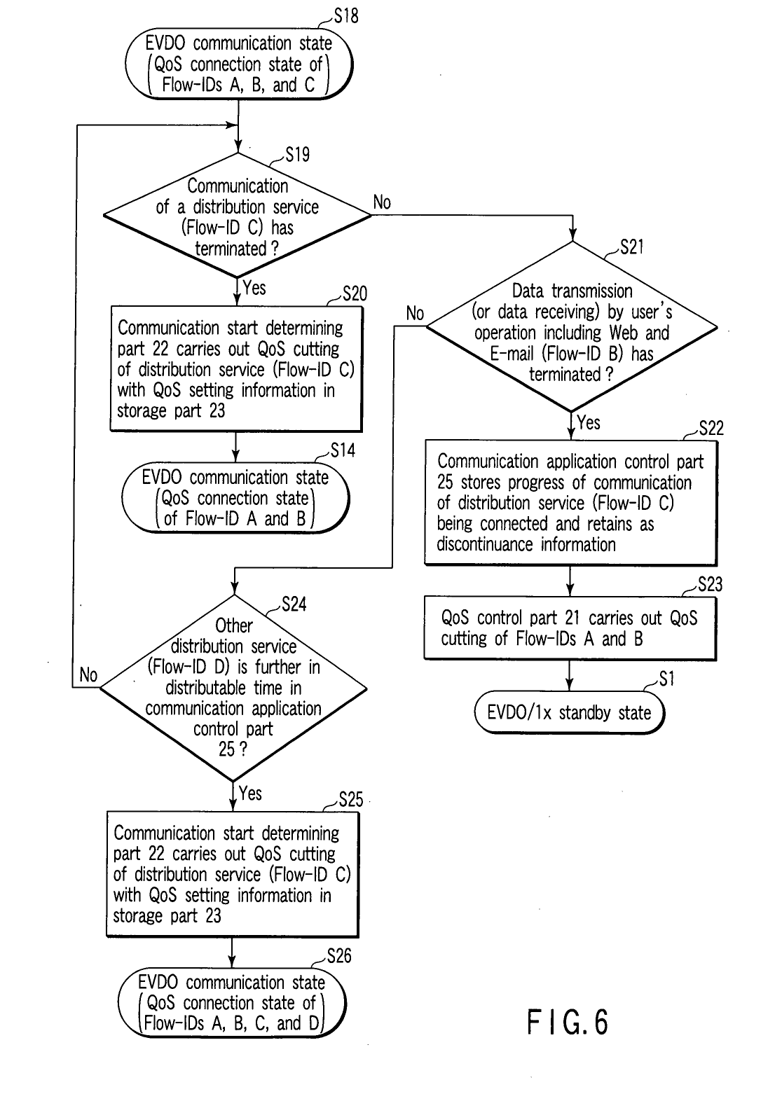

Next, each event after the QoS connection of the Flow-IDs A, B, and C will be described with reference to a flowchart in FIG. 6.

In the EVDO communication state (QoS connection state of the Flow-IDs A, B, and C) (step S18), the QoS control part 21 determines whether the communication of the distribution service (Flow-ID C) has terminated or not (step S19). If the communication has terminated, the QoS control part 21 cuts the QoS connection of the distribution service (Flow-ID C) based on the QoS setting information of the setting table of the setting storage part 23 (step S20), and the state of the mobile phone moves to the EVDO communication state (QoS connection state of the Flow-IDs A and B) (step S14). On the other hand, if the communication of the distribution service (Flow-ID C) has not terminated, the QoS control part 21 determines whether the data communication by the user's operation including Web and E-mail (Flow-ID B) has terminated or not (step S21). If the communication has terminated, the communication application control part 25 stores progress (progress of distribution) of the ongoing distribution service (Flow-ID C), and updates discontinuance information as the status (step S22). Then, the QoS control part 21 cuts the QoS connection of the Flow-IDs A and B (step S23), and the state of the mobile phone moves to the EVDO/1x standby state again (step S1). In the step S21, if the QoS control part 21 determines that the communication has not terminated, the communication application control part 25 further determines whether it has reached time in which the other distribution service (Flow-ID D) can be distributed (step S24), and the QoS control part 21 adds the QoS connection of the distribution service (Flow-ID D) based on the QoS setting information of the setting storage part 23 by receiving an instruction from the communication start determining part 22 (step S25). In this manner, the state of the mobile phone moves to the EVDO communication state (QoS connection state of the Flow ID A, B, C, and D) (step S26). In step S24, if it has not reached the distributable time, the processing returns to step S19, and the processing in steps S21 and S24 is repeated.

As has been described so far, in the mobile phone according to the first embodiment, the communication start determining part 22 detects start of the packet communication carried out by the intention of the user, and the detection of the start triggers the QoS control part 21 to refer to the setting table stored in the setting storage part 23, and carry out the QoS connection of the Flow-IDs A and B based on each priority. The communication application control part 25 periodically checks a state of the distribution service even when the QoS connection continues, and when it is in a state where the content distribution 1 can be distributed, the QoS control part 21 adds the QoS connection of the Flow-ID C in accordance with priority of the setting storage part 23. Further, the communication state continues and at the time the content distribution 2 can be distributed, the QoS control part 21 adds the QoS connection of the Flow-ID D in accordance with priority in a similar manner. Thereafter, each data communication service is carried out in accordance with each priority managed by the communication application control part 25.

In the communication, Web communication by the user (Flow-ID B) has the highest priority of the services B, C, and D. At the time when the packet communication of the Flow-ID B is terminated by the user's operation, there is no problem if downloading of the Flow-IDs C and D has terminated. However, if the downloading has not terminated, communication of the Flow-IDs C and D may be discontinued once at this point. In this case, the communication application control part 25 updates the status of the setting table of the setting storage part 23 and writes the discontinuance information, thereby the communication of the Flow-IDs C and D can be resumed at the time of the QoS connection by the user's operation at the next time.

### Second Embodiment

The mobile phone according to this second embodiment carries out the QoS connection for the data communication of Web carried out by the intention of the user, starts downloading of a distribution content in the background simultaneously therewith, and continues the downloading of the distribution content even after the data communication terminates.

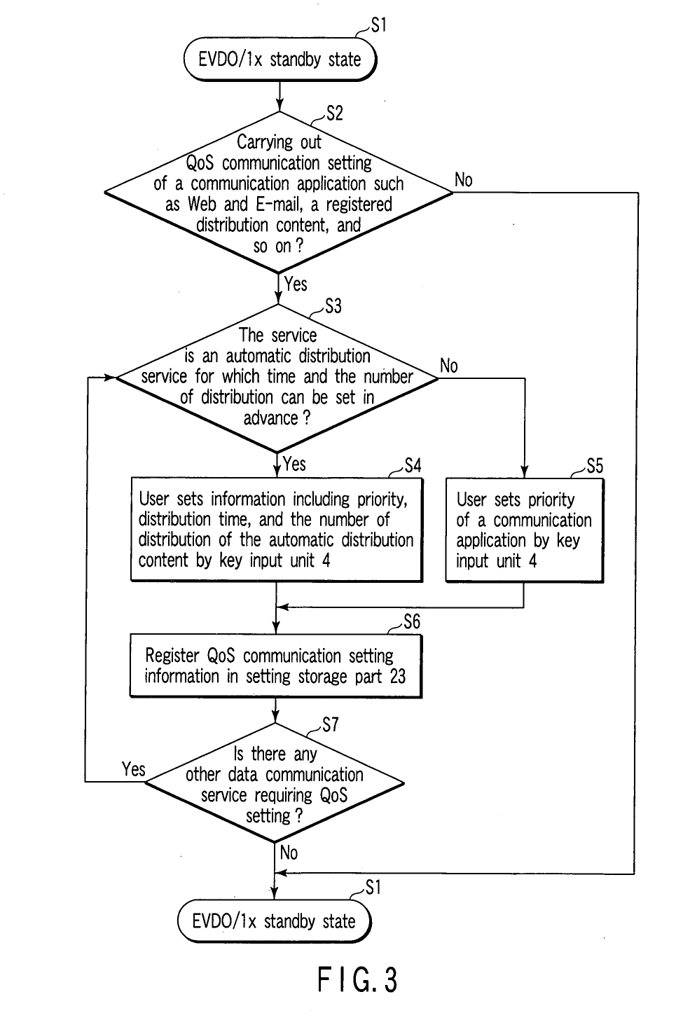

A configuration of the mobile phone according to the second embodiment is similar to the first embodiment described above. Therefore, an overlapping explanation is omitted here, and the following explanation proceeds with reference to FIG. 1 as appropriate. In addition, processing steps for the QoS communication setting are as described above in FIG. 3.

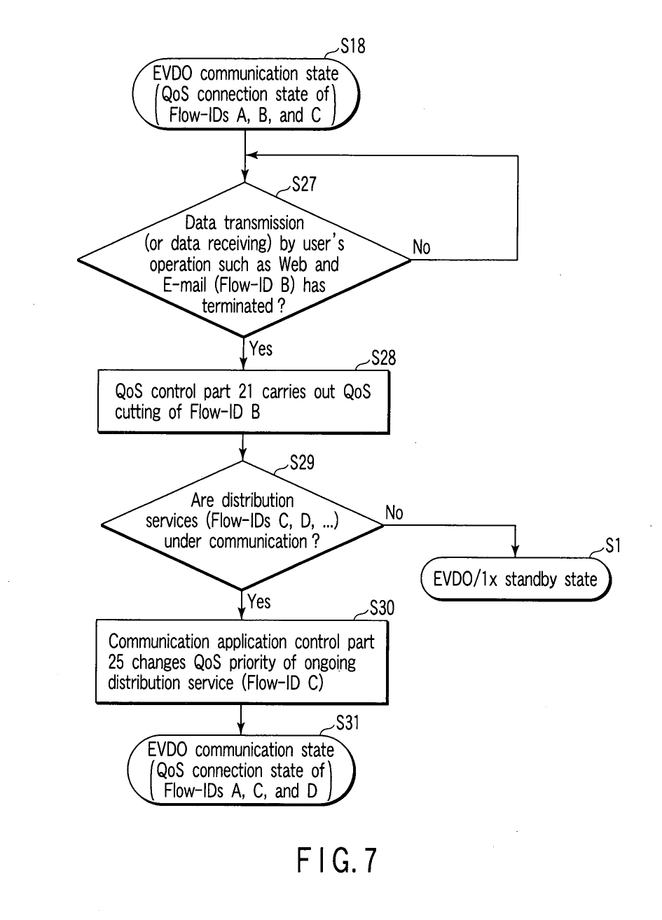

Hereinafter, processing steps by the mobile phone according to the second embodiment of the present invention will be described in detail with reference to flowcharts in FIGS. 7 to 9.

First, each event after connecting the Flow-IDs A, B, and C will be described with reference to a flowchart in FIG. 7.

In the EVDO communication state (QoS connection state of the Flow-IDs A, B, and C) (step S18), the QoS control part 21 determines whether the data communication by the user's operation such as Web and E-mail (Flow-ID B) has terminated (step S27). Here, in case the data communication is determined to have terminated, the QoS control part 21 cuts the QoS connection of the Flow-ID B and the processing moves to step S29 (step S28). On the other hand, in case the data communication has not terminated, the processing moves to step S29 as it is.

In step S29, the QoS control part 21 determines whether the distribution services (Flow-ID C and D) are under communication or not (step S29). Here, if the distribution services are determined as being under communication, the communication application control part 25 changes priority of the ongoing distribution service (Flow-ID C) (step S30), and the state of the mobile phone moves to the EVDO communication state (QoS connection state of the Flow-IDs A, C, and D) (step S31). On the other hand, if the distribution services are not under communication, the state of the mobile phone moves to the EVDO/1x standby state (step S1).

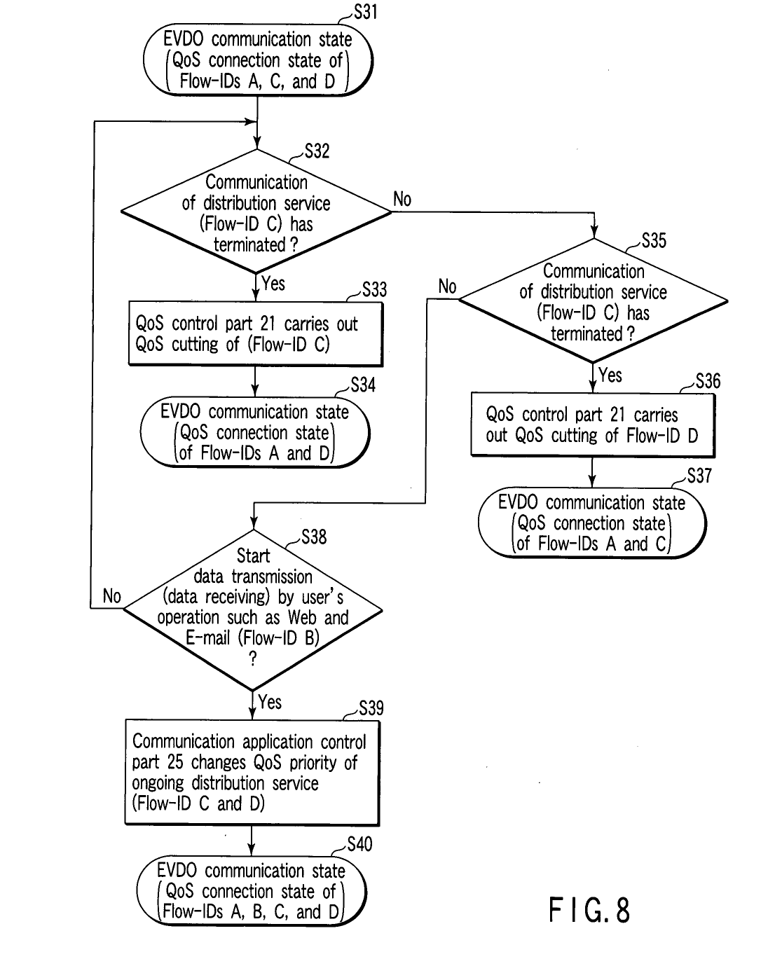

Next, each event after connecting the Flow-IDs A, C, and D will be described with reference to a flowchart in FIG. 8. In the EVDO communication state (QoS Connection State of the Flow-Ids a, C, and D) (step S31), the QoS control part 21 determines whether distribution of the distribution service (Flow-ID C) has terminated or not (step S32). Here, if the distribution has terminated, the QoS control part 21 cuts the QoS connection of the Flow-ID C (step S33), and the state of the mobile phone moves to the EVDO communication state (QoS connection state of the Flow IDs A and D) (step S34). On the other hand, if the distribution of the distribution service (Flow-ID C) has not terminated, the QoS control part 21 determines whether the distribution of the distribution service (Flow-ID D) has terminated or not (step S35). Here, if the distribution has terminated, the QoS control part 21 cuts the QoS connection of the Flow-ID D (step S36), and the state of the mobile phone moves to the EVDO communication state (QoS connection state of the Flow-ID A and C) (step S37). On the other hand, if the distribution of the distribution service (Flow-ID D) has not terminated, the QoS control part 21 determines again whether data transmission (or data receiving) carried out by the user's operation such as Web and E-mail (Flow-ID B) has started or not (step S38). Again, if the communication has not started, the communication application control part 25 changes priority of the ongoing distribution services (Flow-IDs C and D) (step S39). More specifically, due to addition of the Flow-ID B, priority of the Flow-ID C or D is lowered. Here, priority is set to be B>C>D. Thereafter, the state of the mobile phone moves to the EVDO communication state (QoS connection state of the Flow-IDs A, B, C, and D) (step S40).

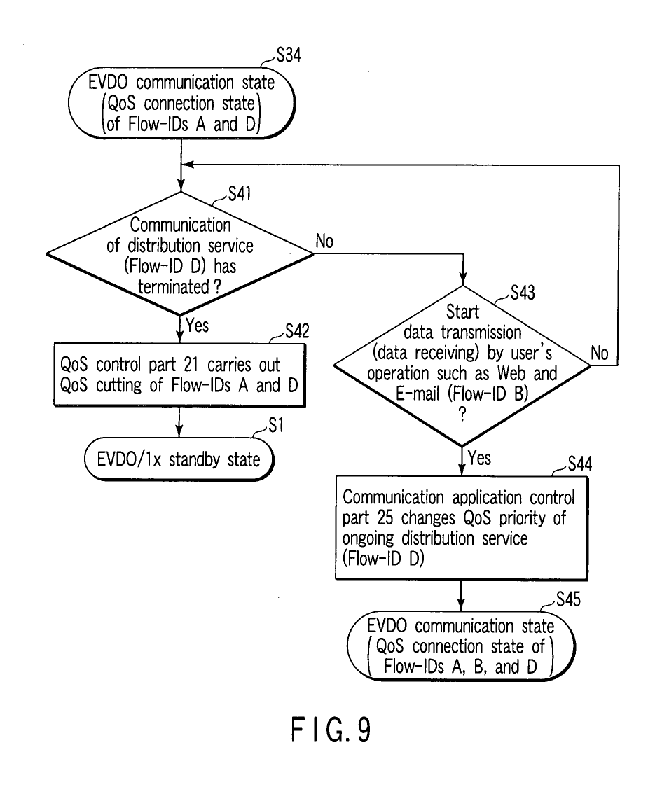

Next, each event after connecting the Flow-IDs A and D will be described with reference to a flowchart in FIG. 9. In the EVDO communication state (QoS connection state of the Flow-IDs A and D) (step S34), the QoS control part 21 determines whether distribution of the distribution service (Flow-ID D) has terminated or not (step S41). Here, if the distribution is determined to have been terminated, the QoS control part 21 cuts the QoS connection of the Flow-IDs A and D (step S42), and the state of the mobile phone moves to the EVDO/1x standby state (step S1).

On the other hand, if the distribution of the distribution service (Flow-ID D) has not terminated, the QoS control part 21 again determines whether the data transmission (or data receiving) carried out by the user's operation such as Web and E-mail has started or not (step S43). Again, if the communication has started, the communication application control part 25 changes priority of the ongoing distribution service (Flow-ID D) (step S44). More specifically, due to addition of the Flow-ID B, priority of the Flow-ID D is decreased. That is, priority is set as A>B>D. Thereafter, the state of the mobile phone moves to the EVDO communication state (QoS connection state of the Flow-IDs A, B, and D) (step S45).

As has been described so far, in the mobile phone according to the second embodiment, the QoS connection is carried out by Web connection carried out by the user, downloading of distribution starts in the background simultaneously, and the downloading of the distribution content is continued even after the user's communication terminates. In order to complete communication of the Flow-IDs C and D (however, a screen of the liquid crystal display unit 3 is in a standby state), the communication can be continued in the background. At this time, priority of the Flow-IDs C and D is increased at the time when the communication application control part 25 does not use the QoS in the Flow-ID B.

### Third Embodiment

The mobile phone according to a third embodiment of the present invention carries out connection for data communication of Web carried out by the user, starts downloading of distribution in the background simultaneously, monitors throughput for each service at this time, and changes priority in accordance with a communication state.

A configuration of the mobile phone according to the third embodiment is similar to the first embodiment shown above. Therefore, an overlapping explanation is omitted, and the following explanation proceeds with reference to FIG. 1 as appropriate. In addition, processing steps of the QoS communication setting is as described above in FIG. 3.

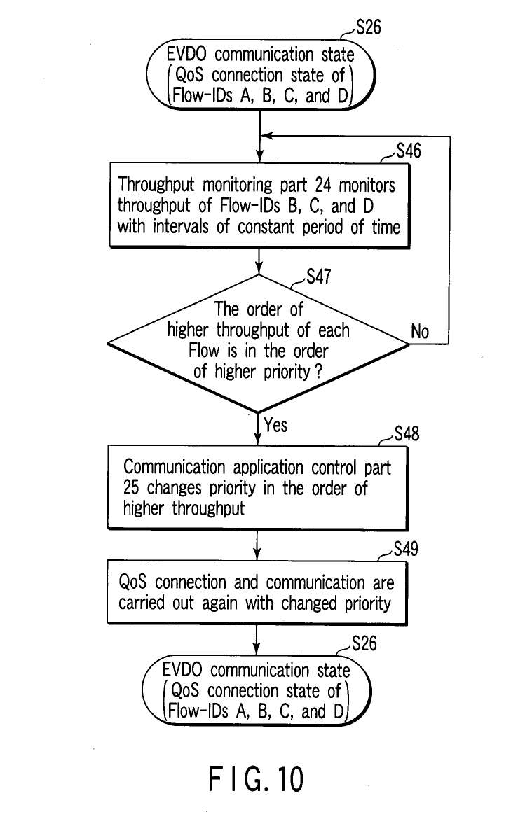

Hereinafter, processing steps of the mobile phone according to the third embodiment will be described in detail with reference to a flowchart in FIG. 10.

In the third embodiment, the throughput monitoring part 24 monitors throughput for each service, and changes priority in accordance with a communication state. That is, in the EVDO communication state (QoS connection state of the Flow-IDs A, B, C, and D) (step S34), the throughput monitoring part 24 monitors throughput of the Flow-IDs B, C, and D with intervals of a constant period of time (step S46). For example, there is no problem if throughput is in the order of higher priority, b>c>d. However, the throughput monitoring part 24 monitors communication when such communication has low throughput despite high priority.

Then, the QoS control part 21 determines whether the order of higher throughput is in the order of higher priority for each data communication service (step S47). Here, in a case the order of higher throughput is not in the order of higher priority, the processing returns to step S46 and the above processing is repeated. On the other hand, if the order of higher throughput is in the order of higher priority, the communication application control part 25 changes priority in the order of higher throughput (step S48). For example, if the order of priority is set as B>C>D and the order of throughput is set as C>B>D, the order of priority is changed to C>B>D. In this manner, the QoS control part 21 carries out the QoS connection again in the changed order of priority, carries out communication (step S49), and again the state of the mobile phone moves to the EVDO communication state (QoS connection state of the Flow-IDs A, B, C, and D) (step S26).

As described above, according to the mobile phone according to the third embodiment, the throughput monitoring unit 4 of the communication control unit 2 monitors a communication state of each data communication service and dynamically changes priority in accordance with a result of the monitoring, thereby overall communication can be carried out efficiently. For example, at the time of starting communication, priority of the Flow-ID B is high, however, throughput is lowered if delay occurs due to overloading on a server. At this time, the QoS control part 21 lowers priority of the Flow-ID B, and increases priority of the Flow-ID C or D. In this manner, communication of the Flow-IDs C and D terminate earlier without having much impact on communication of the Flow-ID B, thereby effective use and increase in efficiency of an overall communication path can be attempted.

According to the present invention, there is provided a mobile phone capable of performing efficient data communication by effectively using resources by performing periodical distribution and so on of a registered content in the background with a start of communication as a trigger if the user carries out target data communication by QoS control, and also attempting decrease in the number of communication and communication time and reduction in power consumption.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile phone for a communication in relation to a plurality of data communication services, comprising:
a storing part configured to store priorities relating to data communication services; and
a controlling part configured to control the mobile phone to carry out data communication in relation to other data communication services stored in the storing part based on the priority in parallel with packet communication if the packet communication is started.

2. A mobile phone for a communication in relation to a plurality of data communication services, comprising:
an inputting part configured to input a starting operation of packet communication;
a storing part configured to store priorities relating to data communication services; and
a controlling part configured to control the mobile phone to carry out data communication in relation to other data communication services stored in the storing part based on the priority in parallel with packet communication if the packet communication is started in accordance with the starting operation.

3. The mobile phone according to claim 2, wherein
the storing part stores at least one of distribution time, distribution frequency, status, and degree of progress, which relates to data communication service:
the mobile phone further comprises a communication controlling part configured to control communication information including the priority, the distribution time, and the distribution frequency stored in the storing part, which is updated if the communication information including the priority, distribution time and distribution frequency is input via the inputting part.

4. The mobile phone according to claim 1, wherein
the storing part stores distribution time relating to the data communication service, and
the controlling part controls to start data communication in relation to the data communication service associated with the distribution time in parallel with the packet communication, if the controlling part recognizes the distribution time of the data communication service.

5. The mobile phone according to claim 1, wherein
the storing part stores at least one of distribution time, distribution frequency, status, and degree of progress, which relates to the data communication service, and
the communication controlling part stores discontinuance information in the storing part if the data communication in relation to the other data communication services is interrupted in the middle.

6. The mobile phone according to claim 1, wherein
the communication controlling part updates the priority stored in the storing part so as to increase priority of the other data communication services, if the packet communication and data communication in relation to the other data communication services are executed, and if the packet communication is completed.

7. The mobile phone according to claim 1, wherein
the communication controlling part updates the priority stored in the storing part so as to increase priority of the other data communication services, if the packet communication and data communication in relation to the other data communication services are executed, and if the packet communication is completed, and
the communication controlling part updates the priority stored in the storing part so as to increase the priority of new packet communication if the new packet communication is started.

8. The mobile phone according to claim 1, further comprising throughput monitoring part configured to monitor throughput of each service and communication controlling part, which changes priority of the storing part according to the throughput, if the packet communication is started and data communication in relation to other data communication services is performed in parallel therewith.
